(19) United States
(12) Patent Application Publication
(10) Pub. No.: US 2018/0347340 A1
(43) Pub. Date: Dec. 6, 2018

(54) SQUEEZE TARGET SELECTION METHODS AND SYSTEMS

(71) Applicant: Halliburton Energy Services, Inc., Houston, TX (US)

(72) Inventor: Fady Iskander, Houston, TX (US)

(21) Appl. No.: 15/761,700

(22) PCT Filed: Nov. 13, 2015
(86) PCT No.: PCT/US2015/060636

§ 371 Date: Mar. 20, 2018

(51) Int. Cl. E21B 47/10; E21B 33/138; G01V 5/10; G01V 1/44

(52) U.S. Cl. CPC E21B 47/101; E21B 33/138; E21B 47/18; G01V 1/44; G01V 5/105

(57) ABSTRACT

A method includes obtaining a pulsed neutron log as a function of position along a cased wellbore. The method also includes analyzing the pulsed neutron log to identify a gas channel associated with a surface casing vent flow condition. The method also includes selecting a squeeze target along the identified gas channel. The method also includes directing at least one well intervention tool in the cased wellbore to perform a squeeze operation for the selected squeeze target.

### BACKGROUND

Hydrocarbon exploration and production involves drilling and completing wells. Example well completion operations include installation of casing strings along a drilled wellbore and cementing at least some of the annular space between casings strings and the wellbore wall and/or between overlapping casing strings. Ideally, once a well is completed, fluids should enter or exit the completed well only at intended locations and should not migrate along the wellbore/casing interface. Over time, completed wells sometimes need maintenance and/or need to be abandoned due to lack of production or undesirable surface venting. The surface venting issue refers to unwanted fluid flows (gas and/or liquid) that reach earth's surface either between the surface/production casing annulus or outside the surface casing. Such surface venting is a serious pollution and safety liability as methane gas is flammable, an air pollutant, and a global warming contributor. Also, if water tables are not protected, such surface venting may contaminate these waters. For both active and abandoned wells, compliance with government requirements may necessitate well intervention operations to block or reduce surface venting. An example well intervention to address surface venting involves cutting through the casing and pumping cement into the annular space between casing and wellbore wall (i.e., a “squeeze” operation). While expensive, squeeze operations have been found to successfully reduce or eliminate surface venting when performed at the proper location. Unfortunately, identifying the proper location for a squeeze operation is difficult, resulting in wasted or marginal squeeze operations.

### BRIEF DESCRIPTION OF THE DRAWINGS

Accordingly, there are disclosed herein in the drawings and detailed description squeeze target selection methods and systems. In the drawings:

FIG. 1 is a schematic diagram showing an illustrative surface casing vent flow management scenario;

FIG. 2A is a schematic diagram showing an illustrative drilling environment;

FIG. 2B is a schematic diagram showing an illustrative logging and well intervention environment;

FIG. 3 is a cross-sectional view of a well showing different venting channels;

FIGS. 4A-4C are schematic diagrams showing illustrative pulsed neutron logging tools;

FIG. 5 is a graph showing counts as a function of energy for different types of detectors used with pulsed neutron logging tools;

FIG. 6 is a schematic diagram showing an illustrative ultrasonic cement evaluation logging tool;

FIG. 7A is a schematic diagram showing an illustrative directional noise logging tool;

FIG. 7B is a schematic diagram showing an illustrative distributed sensing arrangement;

FIGS. 8A-8C show illustrative logs used for squeeze target selection;

FIG. 9 is a block diagram of system components used for squeeze target selection; and

FIG. 10 is a flowchart showing an illustrative squeeze target selection method.

It should be understood, however, that the specific embodiments given in the drawings and detailed description do not limit the disclosure. On the contrary, they provide the foundation for one of ordinary skill to discern the alternative forms, equivalents, and modifications that are encompassed in the scope of the appended claims.

### DETAILED DESCRIPTION

Disclosed herein are squeeze target selection methods and systems. In an example method, a pulsed neutron log as a function of position along a cased wellbore is obtained. The pulsed neutron log is analyzed to identify a gas channel associated with a surface casing vent flow condition. A squeeze target is then selected along the identified gas channel. Once a squeeze target is selected, at least one well intervention tool in the cased wellbore can be directed to perform a squeeze operation for the selected squeeze target. Meanwhile, an example system includes at least one well intervention tool configured to perform squeeze operations. Further, the system includes at least one processor and a memory (e.g., a non-transitory computer-readable medium) in communication with the at least one processor. The memory stores instructions that cause the at least one processor to obtain a pulsed neutron log as a function of position along a cased wellbore. Further, the instructions cause the at least one processor to display or identify, based on the pulsed neutron long, a gas channel associated with a surface casing vent flow condition. Further, the instructions cause the at least one processor to select or receive selection of a squeeze target along the identified gas channel. In at least some embodiments, the instructions also cause the at least one processor to direct the at least one well intervention tool to perform squeeze operations at the squeeze target.

Several squeeze target selection method and system options are disclosed herein. For example, in at least some embodiments, a pulsed neutron logging tool with a Bismuth Germinate Oxide (BGO) detector is employed to collect data from which the pulsed neutron log is obtained. With a BGO detector, gas channel identification has higher resolution and/or improved certainty compared to what is possible with other detectors such as Gadolinium Oxyorthosillicate (GSO) detectors, Gadolinium Yttrium Oxyorthosillicate (GYSO) detectors, Lanthanium Tribromide with cerium (LaBr3:Ce) detectors, Yttrium Oxyorthosillicate (YSO), and Sodium Iodide doped with Thallium (NaI(Ti)) detectors. Other squeeze target selection options include obtaining and analyzing additional logs such as an ultrasonic cement evaluation log and/or a directional noise log to pinpoint potential gas sources or eliminate false gas sources. For example, an ultrasonic cement evaluation log can be used to identify gas channels along the casing/cement interface, which may help to pinpoint potential gas sources. As another example, a directional noise log can be used to identify if fluids are flowing up or down at a particular position along a cased wellbore, which may help to pinpoint potential gas sources or eliminate false gas sources. In at least some embodiments, logging tools and computers enable display of a pulsed neutron log, an ultrasonic cement evaluation log, and a directional noise log together to enable an operator to select a squeeze target. Additionally or alternatively, pattern recognition can be applied to one or more logs to facilitate or automate squeeze target selection.

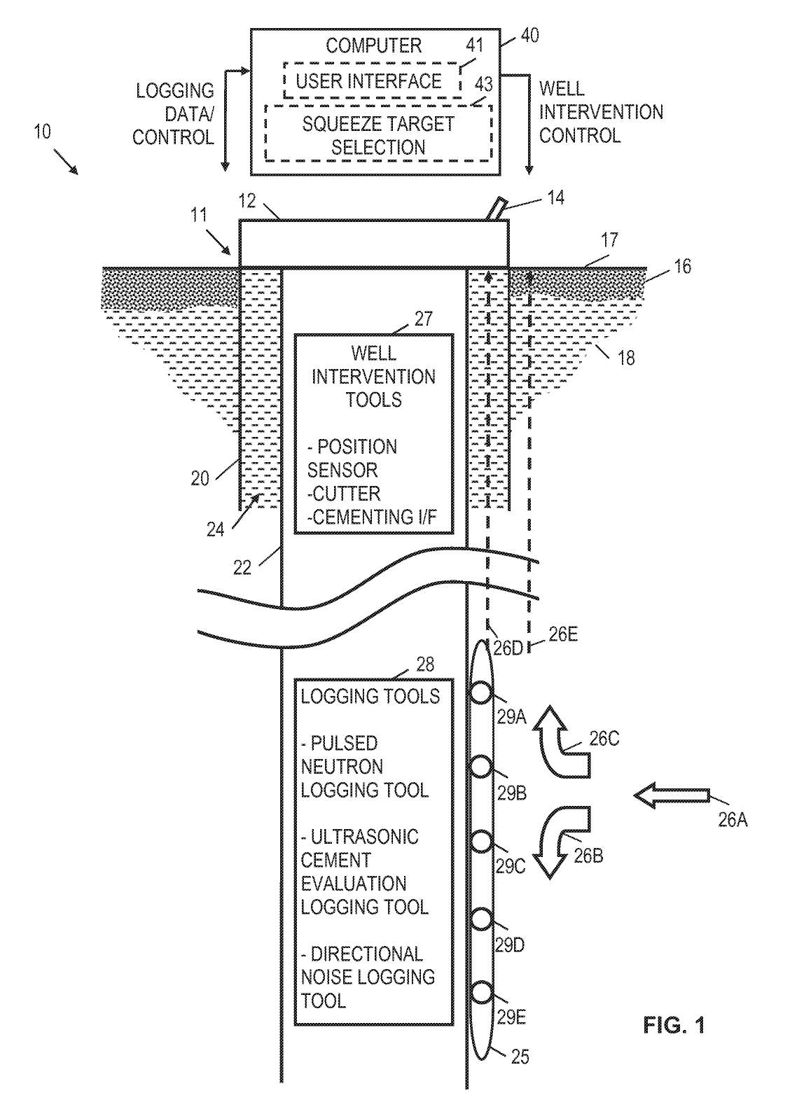

The disclosed systems and methods for squeeze target selection can be best understood in an application context. Accordingly, FIG. 1 shows an illustrative surface casing vent flow management scenario 10. In scenario 10, a well 11 with surface venting issues is represented. The well 11 includes, for example, a wellhead 12 and two casing strings 20, where casing string 20 has a larger diameter than casing string 22. The annular space 24 between the casing strings 20 and 22 as well as the area surrounding the casing string 20 is filled with cement 18 and/or other sealants. At or near earth's surface 17, other materials, such as dirt 16, may cover the area around the well 11.

In scenario 10, surface venting at well 11 is due to at least some fluids (e.g., gas or liquid) under pressure reaching earth” surface 17. In scenario 10, representative fluids are illustrated as fluid flows 26A-26E, where fluid flow 26A results in fluid flows 26B and 26C. As pressure rises, at least some of the fluid flow 26C results in fluid flows 26D and/or 26E. More specifically, fluid flow 26D is shown to reach earth's surface 17 through the annular space 24 between casing strings 20 and 22. Meanwhile, fluid flow 26E is shown to reach earth's surface 17 through the area outside casing string 20. Detection of surface venting is performed at or near the well head 12 using, for example, one or more sensors 14.

In order to stop or reduce surface venting at well 11, a squeeze operation performed at or near fluid flow 26A is needed. In scenario 10, squeeze operations are performed as needed by well intervention tools 27 (e.g., a position sensor, a cutter, a cementing interface, etc.) under the direction of computer 40 and/or other control scheme. To identify an appropriate squeeze target, logging tools 28 as well as computer system 40 are employed. The computer system 40 includes, for example, a user interface 41 and a squeeze target selection module 43 to enable analysis of logging data obtained from logging tools 28 and selection of a squeeze target. The computer system 40 can also enable control of logging tools 28, control of well intervention tools 27, and/or other operations. While scenario 10 shows the logging tools 28 and the well intervention tools 27 deployed at the same time, it should be appreciated that the logging tools 28 and the well intervention tools 27 can be deployed at different times.

In at least some embodiments, the logging tools 28 includes a pulsed neutron logging tool, an ultrasonic cement evaluation logging tool, and a directional noise logging tool. As an example, a log obtained from the pulsed neutron logging tool may be used to identify a gas channel 25 along a cased wellbore (e.g., along the exterior of the casing string 22). Meanwhile, logs obtained from an ultrasonic cement evaluation logging tool and/or a directional noise logging tool can be used to identify a plurality of suspected gas source zones 29A-29E along the gas channel 25. Logs obtained from a pulsed neutron logging tool, an ultrasonic cement evaluation logging tool, and a directional noise logging tool can be compared to select one the suspected gas source zones 29A-29E as a squeeze target. Once a squeeze target is selected the well intervention can be deployed and/or directed to perform a squeeze operation at the selected squeeze target. At earth's surface, one or more sensors 14 collects surface venting data as function of time. If the squeeze operation is successful, surface venting for well 11 will be reduced or eliminated. If surface venting for well 11 stays above a threshold, one or more additional squeeze operations can be performed until surface venting for well 11 is sufficiently reduced or eliminated. Each additional squeeze operation may be based on analysis of the same set of logs as the previous squeeze operation, or a new set of logs can be collected and analyzed (e.g., to identify how the previous squeeze operation affected the gas channel 25 and/or other squeeze target identifiers).

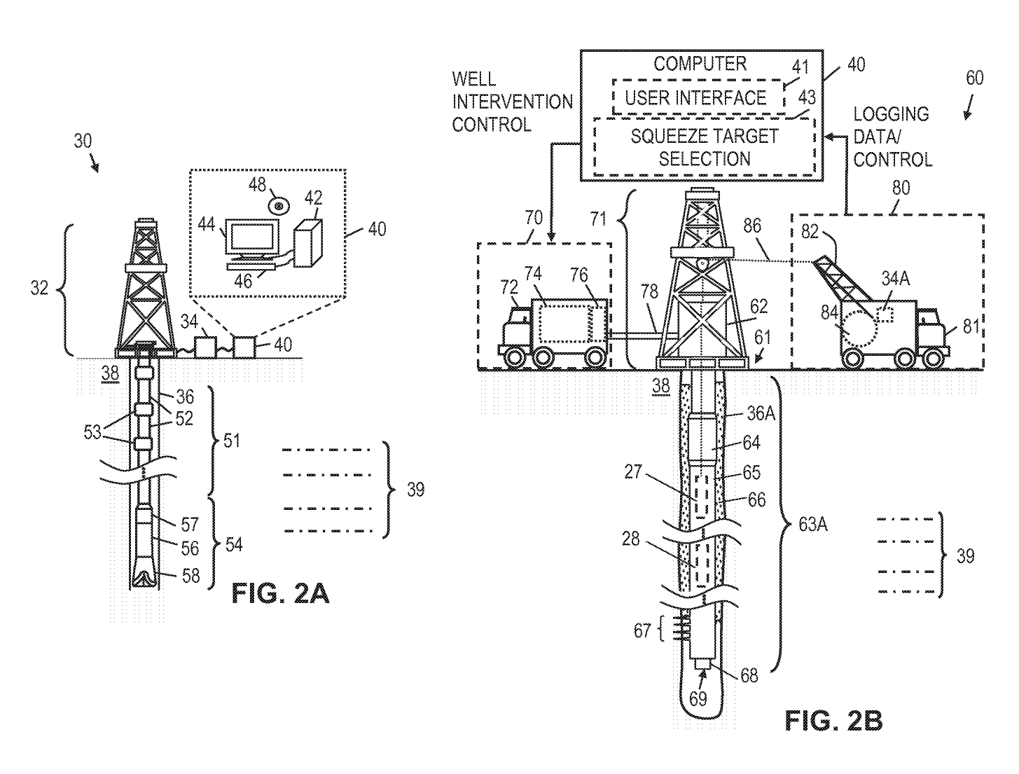

FIG. 2A shows an illustrative drilling environment 30 related to forming a well (e.g., well 11 of FIG. 1). In environment 30, a drilling assembly 32 lowers and/or raises a drill string 51 in a wellbore 36 that penetrates formations 39 of the earth 38. The drill string 51 is formed, for example, from a modular set of drill pipe sections 52 and adaptors 53. At the lower end of the drill string 51, a bottomhole assembly 54 with a drill bit 58 removes material from the formation 38 using known drilling techniques. The bottomhole assembly 54 also includes one or more drill collars 57 and may include a logging tool 56 to collect measurement-while-drilling (MWD) and/or logging-while-drilling (LWD) data.

In FIG. 2A, an interface 34 at earth's surface receives the MWD and/or LWD measurements via mud based telemetry or other wireless communication techniques (e.g., electromagnetic, acoustic). Additionally or alternatively, a cable (not shown) including electrical conductors and/or optical waveguides (e.g., fibers) may be used to enable transfer of power and/or communications between the bottomhole assembly 54 and earth's surface. Such cables may be integrated with, attached to, or inside components of the drill string 51 (e.g., IntelliPipe sections may be used).

The interface 34 may perform various operations such as converting signals from one format to another, filtering, demodulation, digitization, and/or other operations. Further, the interface 34 conveys the MWD data, LWD data, and/or data to a computer system 40 for storage, visualization, and/or analysis. Additionally or alternatively to processing MWD or LWD data by a computer system at earth's surface, such MWD or LWD data may be partly or fully processed by one or more downhole processors (e.g., included with bottomhole assembly 54).

In at least some embodiments, the computer system 40 includes a processing unit 42 that enables visualization and/or analysis of MWD data and/or LWD data by executing software or instructions obtained from a local or remote non-transitory computer-readable medium 48. The computer system 40 also may include input device(s) 46 (e.g., a keyboard, mouse, touchpad, etc.) and output device(s) 44 (e.g., a monitor, printer, etc.). Such input device(s) 46 and/or output device(s) 44 provide a user interface that enables an operator to interact with the logging tool 56 and/or software executed by the processing unit 42. For example, the computer system 40 may enable an operator to select visualization and analysis options, to adjust drilling options, and/or to perform other tasks. Further, the MWD data and/or LWD data collected during drilling operations may facilitate determining the location of subsequent well completion options and/or other downhole operations.

At various times during the drilling process, the drill string 51 shown in FIG. 2A may be removed from the wellbore 36. With the drill string 51 removed, logging tools (e.g., tools 28) and/or well intervention tools (e.g., tools 27) may be deployed via wireline, slickline, or coiled tubing. In accordance with at least some embodiments, the disclosed logging and well intervention environment 60 includes to a completed or partially-completed well such as well 11 in FIG. 1.

In the logging and well intervention environment 60 of FIG. 2B, a well 61 has been formed by drilling a wellbore 36A that penetrates formations 39 of the earth 38 (e.g., as in the drilling environment 30 of FIG. 2A). The well 61 includes a casing string 63A positioned in the wellbore 36A, where the casing string 63A may include multiple tubular casing sections 65 (usually about 30 feet long) connected end-to-end by couplings 64. Note: FIG. 2B is not to scale, and that casing string 63A typically includes many such couplings 64. Further, the well 61 may include cement 66 that has cured after being injected into the annular space between the outer surface of the casing string 63A and the inner surface of the wellbore 36A. Further, in at least some embodiments of the well 36A, a production tubing string 68 has been positioned in an inner bore of the casing string 63A.

A function of the well 61 is to guide a desired fluid (e.g., oil or gas) from a section of the wellbore 36A to earth's surface. In at least some embodiments, perforations 67 may be formed at one or more points along the wellbore 36A to facilitate the flow of a fluid from a surrounding formation into the wellbore 36A and thence to earth's surface via an opening 69 at the bottom of the production tubing string 68. Note: the well 61 is illustrative and not limiting on the scope of the disclosure. For example, other wells may be configured as injection wells or monitoring wells. Further, the trajectory and length of wells may vary (e.g., inclined, curved, and horizontal portions are possible). In general, the logging and well intervention operations described herein can be applied to any well where surface venting is an issue.

In at least some embodiments, logging operations involve lowering and raising logging tools 28 through a wellhead 62 and/or other surface components using a wireline 86 guided by a derrick assembly 71. The wireline 86 includes, for example, electrical conductors and/or optical fibers for conveying power to the logging tools 28. The wireline 86 may also be used as a communication interface for uplink and/or downlink communications. In at least some embodiments, the wireline 86 wraps and unwraps as needed around reel 84 when lowering or raising logging tools 28. As shown, the reel 84 may be part of a wireline assembly 80 that includes, for example, a movable facility or vehicle 81 having a wireline guide 82. The moveable facility or vehicle 81 also includes an interface 34A in communication with a computer system 40. As previously discussed, the computer system 40 may include a user interface 41 and a squeeze target selection module 43 to enable analysis of logs collected by the logging tools 28, selection of a squeeze target, and control of well intervention tools 27 as described herein. In alternative embodiments, slickline or coiled tubing can be used instead of wireline 86.

Once a squeeze target is selected, well intervention tools 27 may be deployed via wireline, slickline, or coiled tubing. In at least some embodiments, squeeze operations involve a cementing assembly 70 in communication with the computer system 40 or operator. The cementing assembly 70 may include a movable facility or vehicle 72 having a cement slurry tank 74 and a pump 76 to convey cement slurry from the tank 74 to one or more conduits 78 to enable pumping of cement slurry to the squeeze target. At the squeeze target, well intervention tools may cut or otherwise prepare an opening in the casing string 63A to enable the cement slurry to reach an exterior of the casing string 63A. While the logging and well intervention environment 60 shows the logging tools 28 and the well intervention tools 27 deployed at the same time, it should be appreciated that the logging tools 28 and the well intervention tools 27 can be deployed at different times.

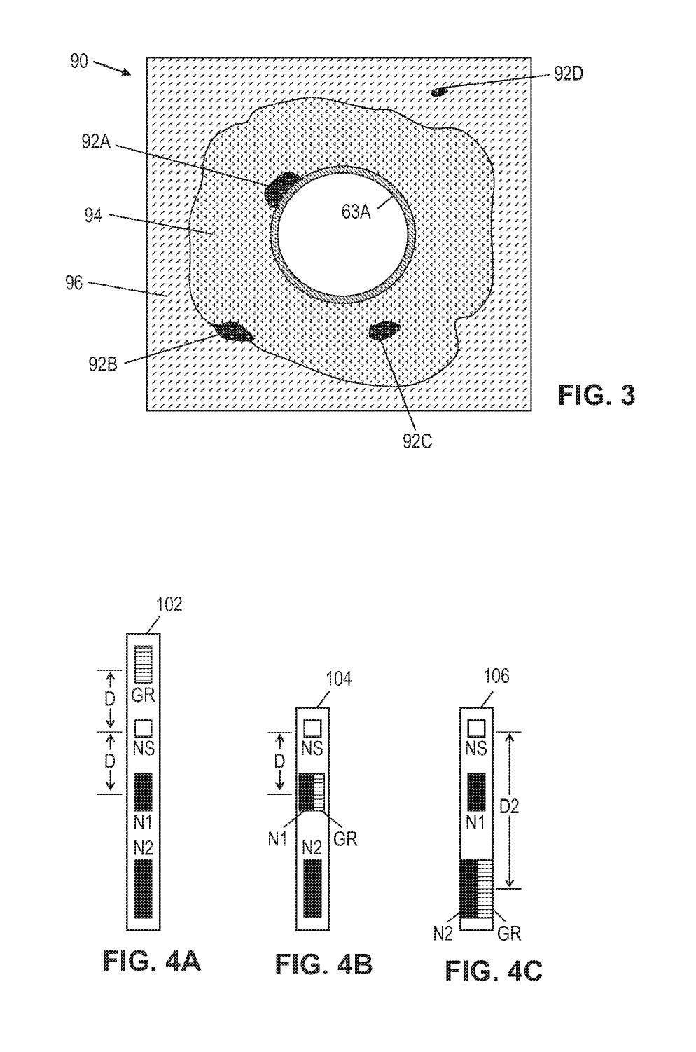

FIG. 3 is a cross-sectional view showing a well environment 90 with different venting channel types 92A-92D. The first venting channel type 92A extends between an exterior of casing string 63A and the cement 94. The second venting channel type 92B extends between the formation 96 and the cement 94 (e.g., along the wellbore wall). The third venting channel type 92C extends through the cement 94. The fourth venting channel type 92D extends through the formation 96. Surface venting can result from one or more of these venting channel types 92A-92D extending (or overlapping each other) between a gas source and earth's surface. The disclosed techniques for squeeze target selection are based in part on the assumption that obtaining certain logs and/or considering certain logs together can facilitate identifying the occurrence of one or more of the venting channel types 92A-92D and thus improve squeeze target selection.

In at least some embodiments, logs from a pulsed neutron logging tool are used to identify a gas channel along a cased wellbore, where the gas channel may correspond to one or more of the venting channel types 92A-92D. FIGS. 4A-4C are schematic diagrams showing illustrative pulsed neutron logging tools. FIG. 4A shows a first illustrative embodiment of a pulsed neutron logging tool 102 having a pulsed neutron source (NS) that is positioned equidistant from a gamma ray detector (GR) and a first neutron detector (N1). In an alternative embodiment, the pulsed neutron source can be replaced with a continuous neutron source such as Americium-Beryllium (Am—Be) chemical source. Tool 102 also includes a second neutron detector N2. The two neutron detectors N1 and N2 are sometimes respectively termed the “near” and “far” neutron detectors. The neutron detectors can be designed to count thermal (around about 0.025 eV) and/or epithermal (between about 0.1 eV and 100 eV) neutrons. Suitable neutron detectors include Helium-3 (He-3) filled proportional counters, though of course other neutron counters can also be used. To improve tool performance, each detector can be implemented as a bank of individual detection devices. In accordance with standard neutron porosity tool measurement techniques, the ratio of far-to-near neutron detector counts is indicative of the formation porosity. See, e.g., U.S. Pat. No. 4,570,067 (Larry Gadeken); U.S. Pat. No. 4,625,110 (Harry D. Smith, Jr.); and U.S. Pat. No. 4,631,405 (Harry D. Smith, Jr.).

The gamma ray detector GR can be implemented as a scintillation crystal coupled to a photomultiplier tube. As with the neutron detector, the gamma ray detector can be implemented as a bank of individual detection devices whose results are aggregated. In FIG. 4A, the gamma ray detector is “co-distant” with the near neutron detector N1, i.e., it is positioned at the same distance D from the source NS as the near neutron detector N1. In the embodiment of FIG. 4A, the gamma ray detector GR and the neutron detector N1 are located in opposite directions from neutron source NS. FIG. 4B shows an alternative embodiment in which a neutron porosity tool 104 has a gamma ray detector GR and a near neutron detector N1 co-located, i.e., located side-by-side at the same distance D from the neutron source NS. FIG. 4C shows yet another alternative embodiment in which a neutron porosity tool 106 has a gamma ray detector GR and a far neutron detector N2 co-located at a distance D2 from the neutron source NS.

The multiple neutron detectors N1, N2 of tools 102, 104, and 106, enable the tools to measure formation porosity using any of the existing multiple-spacing techniques. In addition, the presence of a gamma ray detector GR having a common distance from the source with one of the neutron detectors, enables the measurement of a gas channel as will be discussed further below.

In at least some embodiments, the pulsed neutron logging tool, used to obtain logs from which a gas channel along a cased wellbore is identified, corresponds to one of Halliburton's Reservoir Monitoring Tools (e.g., RMT Elite™ or RMT 3D™). In such case, BGO (Bismuth Germanium Oxide) detectors are employed to identify the migration of gas in different venting channel types 92A-92D that cannot be seen in cement evaluation logs. While embodiments are not limitations to BGO detectors, it has been found that BGO detectors enable identification of gas migration in smaller quantities that other available tools. The ability to identify gas migration in smaller quantities is due to BGO detectors being denser and larger than other detectors. Table 1 shows a comparison between different types of available detectors.

TABLE 1

| Detector Type | | Density (g/cc) |
|---|---|---|
| BGO | Bismuth Germanium Oxide | 7.13 |
| GSO | Gadolinium Oxyorthosillicate | 6.71 |
| GYSO | Gadolinium Yttrium Oxyorthosillicate | 6.29 |
| LaBr3:Ce | Lanthanium tribromide (cerium activated) | 5.30 |
| YSO | Yttrium Oxyorthosillicate | 4.45 |
| NaI(Ti) | Sodium Iodide (Thallium doped) | 3.67 |

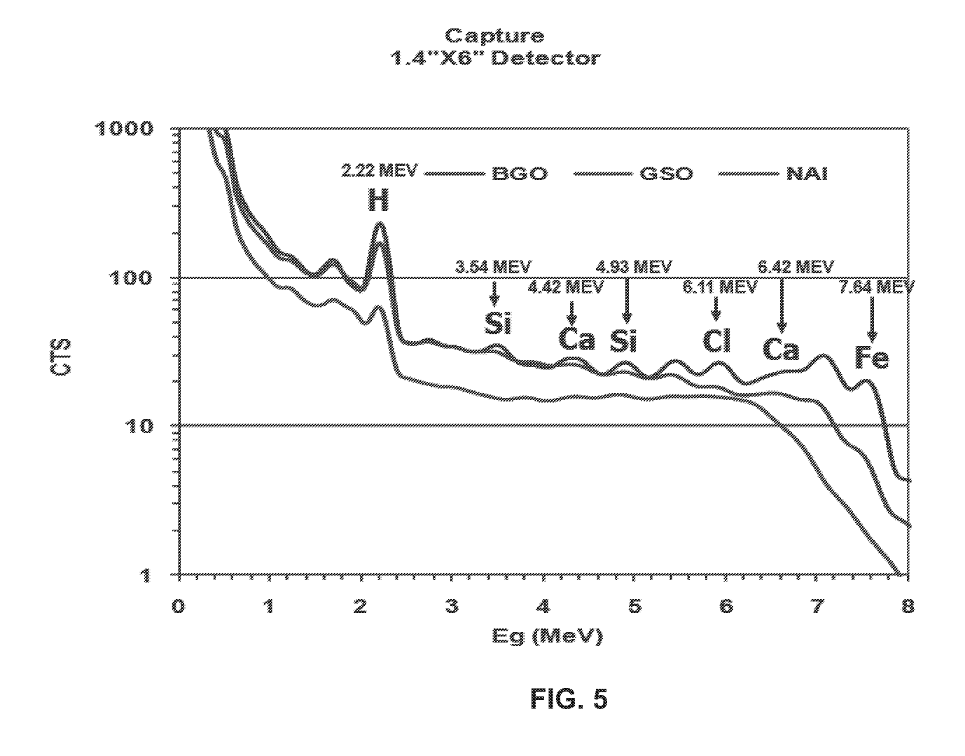

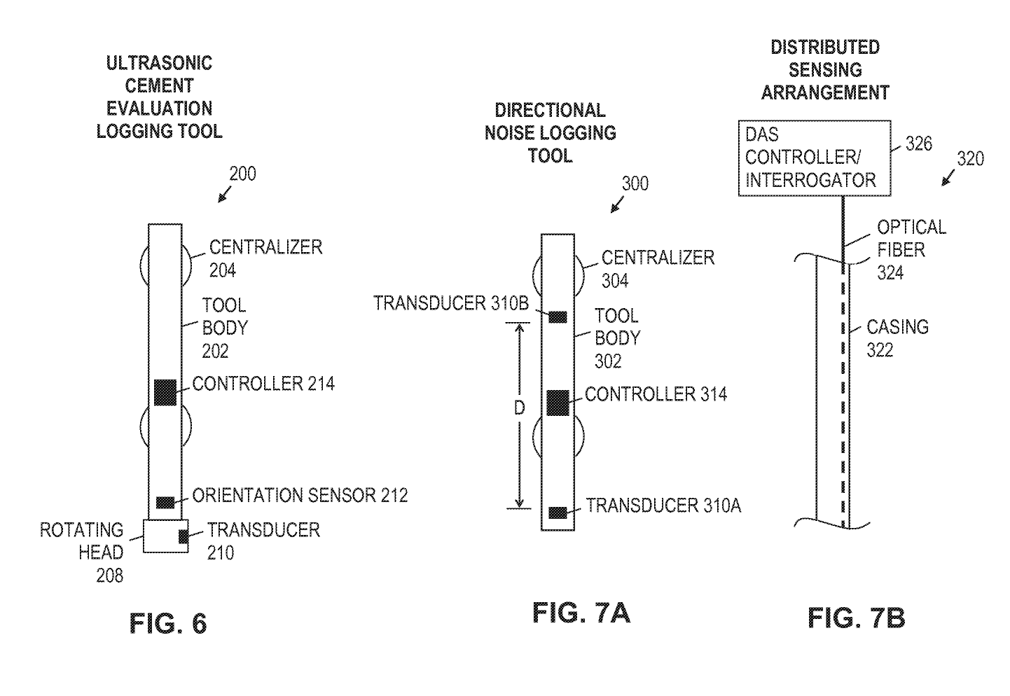

As shown in Table 1, BGO detectors have higher density than other detectors. FIG. 5 is a graph showing counts as a function of energy for different types of detectors. As shown in FIG. 5, BGO detectors can result in more counts, thus producing a more definitive spectrum from which to identify gas migration. With a large BGO detector, gas migration can be identified in small cracks of cement or along the cement to formation interface. As previously explained, other logs besides a pulsed neutron log can be employed to select a squeeze target. For example, in at least some embodiments, an ultrasonic cement evaluation log obtained by an ultrasonic cement evaluation logging tool can be considered. FIG. 6 is a schematic diagram showing an illustrative ultrasonic cement evaluation logging tool 200 that can be deployed along a cased wellbore to obtain an ultrasonic cement evaluation log. In FIG. 6, the ultrasonic cement evaluation logging tool 200 includes a tool body 202 with one or more centralizers 204. The tool 200 also includes a rotating head 208 with a transducer 210. As the rotating head 208 rotates, the transducer 210 emits and receives acoustic signals that can be used to generate a log of the surrounding cased wellbore. Control of the transducer 210 and data storage is provided by controller 214. An orientation sensor 212 and/or other components may also be included to facilitate interpretation of measurements obtained by the ultrasonic cement evaluation logging tool 200.

In at least some embodiments, a directional noise log obtained by a directional noise logging tool can be considered. FIG. 6 is a schematic diagram showing an illustrative ultrasonic cement evaluation logging tool 200 that can be deployed along a cased wellbore to obtain an ultrasonic cement evaluation log. In FIG. 6, the ultrasonic cement evaluation logging tool 200 includes a tool body 202 with one or more centralizers 204. The tool 200 also includes a rotating head 208 with a transducer 210. As the rotating head 208 rotates, the transducer 210 emits and receives acoustic signals that can be used to generate a log of the surrounding cased wellbore. Control of the transducer 210, data storage, and telemetry is provided by controller 214, which represents one or more components and/or circuits. An orientation sensor 212 and/or other components may also be included to facilitate interpretation of measurements obtained by the ultrasonic cement evaluation logging tool 200. In some embodiments, tool 200 may have more than one transducer from which acoustic signals are emitted and/or received. In at least some embodiments, the ultrasonic cement evaluation logging tool 200 corresponds to one of Halliburton's Circumferential Acoustic Scanning Tools (e.g., a CAST-M™ tool)

FIG. 7A is a schematic diagram showing an illustrative directional noise logging tool 300. In FIG. 7A, the directional noise logging tool 300 includes a tool body 302 with one or more centralizers 304. The tool 300 also includes spaced transducers 310A and 310D, separated by a distance (D). Data collection by the spaced transducers 310A and 310D, data storage, and telemetry is provided by controller 314, which represents one or more components and/or circuits. The distance (D) between the spaced transducers 310A and 310D and sensitivity to different frequency bands results in directional noise logs for different frequency bands. In this manner, the intensity and direction of downhole noise (e.g., due to gas migration) can be logged and analyzed.

Another way to obtain a directional noise log involves distributed acoustic sensing. FIG. 7B is a schematic diagram of a distributed sensing arrangement 320 that can be used to obtain a directional noise log. As shown, the distributed sensing arrangement 320 includes an optical fiber 324 deployed along a casing 322, where a distributed acoustic sensing (DAS) controller/interrogator 326 provides an interrogation signal to the optical fiber 324 and collects backscattered light. Analysis of the backscattered light (e.g., interferometry and phase analysis) can be performed using known techniques to identify intensity and direction of acoustic activity occurring along the optical fiber 324. The acoustic activity for one or more frequency bands can be plotted as a function position along the optical fiber 324 (i.e., along a cased wellbore). In different embodiments, distributed sensing may involve a single optical fiber, multiple sensors (e.g., Bragg gratings or Fabry-Perot sensors) distributed along one or more optical fibers, distributed acoustic-to-optical transducers, or other arrangements.

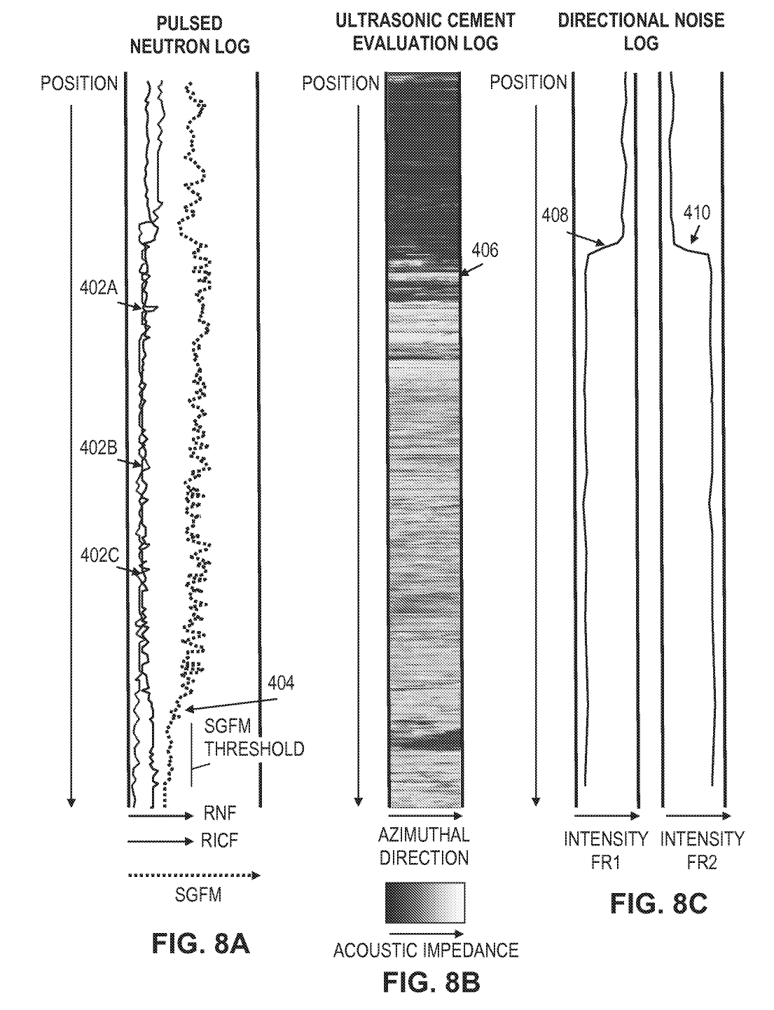

FIGS. 8A-8C show illustrative logs used for squeeze target selection. More specifically, FIG. 8A shows a pulsed neutron log, FIG. 8B shows an ultrasonic cement evaluation log, and FIG. 8C shows a directional noise log. The logs of FIG. 8A-8C are plotted as a function of position as may be displayed together to facilitate squeeze target selection. As an example, FIG. 8A shows a pulsed neutron log as a function of position along a cased wellbore. In FIG. 8A, a gas channel can be identified from portions of a SGFM line 404 that exceed a threshold. As used herein, “SGFM” refers to a formation capture cross section, which has been diffusion corrected. In at least some embodiments, the SGFM values (Σ_{FM}^{CORR}) are calculated from the short-spaced and long-spaced detector data (e.g., primarily from Σ_{FM-SS} after being corrected for diffusion effects). Further, crossover areas 402A-402C related to an RNF line and an RICF line in the pulsed neutron log of FIG. 8A may be associated with suspected gas source zones along the gas channel. As used herein, “RNF” refers to ratio of near-to-far detector count rate with a behavior similar to a neutron porosity curve. Meanwhile, “RICF” refers to ratio of inelastic-to-capture count rates for the long-spaced detector. RICF is useful in differentiating between gas-bearing and low-porosity formations. RICF will track RNF in liquid filled formations and deflect similarly with porosity changes. In contrast to RNF, RICF is insensitive to gas in the formation.

FIG. 8B shows an ultrasonic cement evaluation log as a function of position and azimuth along a cased wellbore. The grayscale color in FIG. 8B corresponds to acoustic impedance. In other words, the ultrasonic cement evaluation log indicates an ability to stop sound, which can be correlated with how much cement is behind the casing. In the example log of FIG. 8B, the acoustic impedance scale varies between 0 (black) to 6.15 (white), where higher acoustic impedance indicates an increased bond between the casing string and cement behind the casing string. It should be appreciated that other color scales or acoustic impedance visualization options may be used for an ultrasonic cement evaluation log. In the ultrasonic cement evaluation log such of FIG. 8B, one or more transition points 406 may be identified and correlated with gas migration (i.e., a lower acoustic impedance is indicated above point 406, which may be due to gas migration decreasing the bond between the casing string and cement behind the casing string).

FIG. 8C shows a directional noise log as a function of position along a cased wellbore. In the directional noise log of FIG. 8C, a transition point 408 for a first frequency range (FR1) and/or a transition point 410 for a second frequency range (FR2) may be identified and correlated with directional variance of gas migration (e.g., below point 408 and/or 410 gas migrates downward and above point 408 and/or 410 gas migrates upward).

In at least some embodiments, logs such as those represented in FIGS. 8A-8C are displayed together to facilitate comparison and select a squeeze target. Further, log normalization and/or scaling operations may be performed to facilitate comparison and select a squeeze target. For example, with the information available in the logs of FIGS. 8A-8C, the crossover area 402A may be selected as the squeeze target due to its position along the gas channel identified in the pulsed neutron log of FIG. 8A, due to its position near the transition point 406 in the ultrasonic cement evaluation log of FIG. 8B, and due to its position near the transition point 408 and/or 410 in the directional noise log of FIG. 8C. The illustrated logs of FIGS. 8A-8C are examples only, and one of ordinary skill in the art would recognize that visualization of log data may vary. Log visualization options may vary with regard to the parameters plotted, two-dimensional (2D) plot options, three-dimensional (3D) plot options, color schemes, user selection of visualization options, etc.

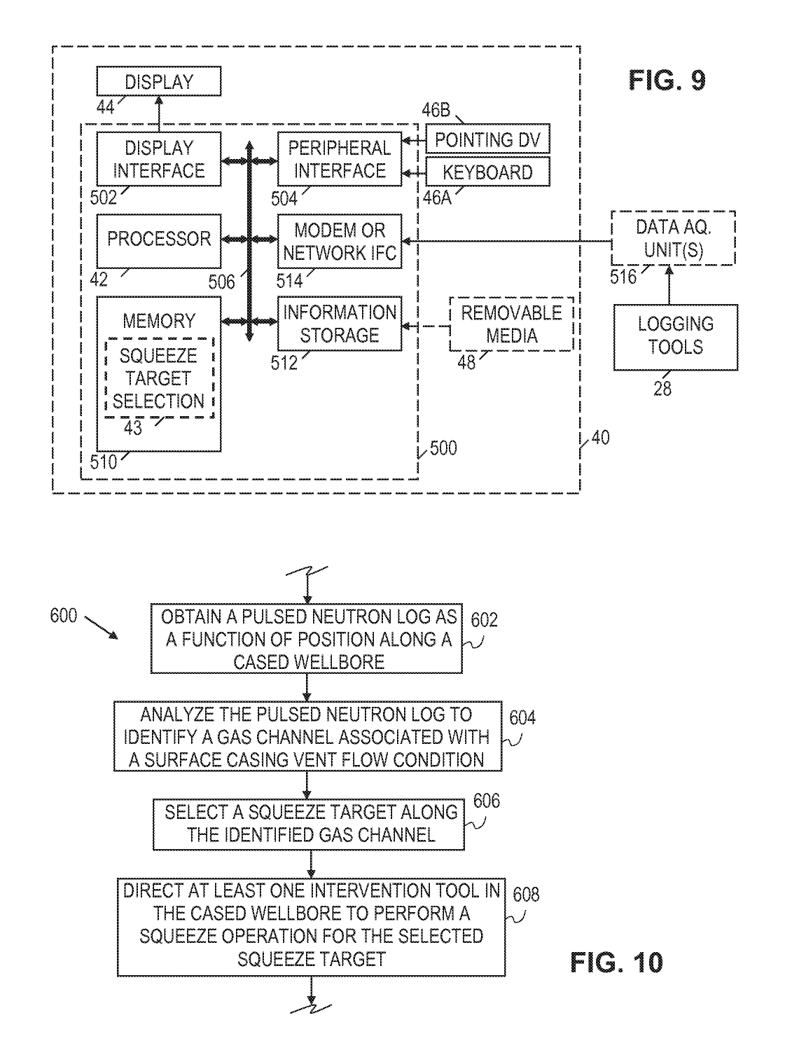

FIG. 9 is a block diagram showing system components used for squeeze target selection as described herein. Some of the components of FIG. 9 may take the form of a computer system 40 that includes a chassis 500, a display 44, and one or more input devices 46A, 46B. Located in the chassis 500 is a display interface 502, a peripheral interface 504, a bus 506, a processor 42, a memory 510, an information storage device 512, and a network interface 514. Bus 506 interconnects the various elements of the computer and transports their communications.

In at least some embodiments, logging tools 28 provide information to the computer system 40 in real-time or in a delayed fashion via data acquisition unit(s) 516 and the network interface 514. Further, the computer system 40 may be employed to send instructions to the logging tools 28. The processor 42, and hence the computer system 40 as a whole, generally operates in accordance with one or more programs stored on an information storage medium (e.g., in information storage device 512, removable information storage media 48, or memory 510). One or more of these programs may correspond to a squeeze target selection module 43 that configures the computer system 40 to display logs and/or to apply rules to log data to identify a squeeze target as described herein. Accordingly, when measurements are obtained from logging tools 28, the processor 42 processes the received measurements to construct corresponding logs for display to a user (e.g., via display 44). Visualization options for such logs may be selected by a user or may be predetermined. Further, squeeze target selection module 43 may enable a user to select or adjust visualization options for obtained logs and/or to select or adjust squeeze selection rules applied to log data

FIG. 10 is a flowchart of an illustrative squeeze target selection method 600. At block 402, a pulsed neutron log as a function of position along a cased wellbore is obtained. At block 404, the pulsed neutron log is analyzed to identify a gas channel associated with a surface casing vent flow condition. In at least some embodiments, a pulsed neutron logging tool with a BGO detector is employed to obtain a pulsed neutron log with sufficient detail to identify the gas channel. At block 406, a squeeze target along the identified gas channel is selected. In at least some embodiments, selecting a squeeze target along the identified gas channel involves obtaining and analyzing additional logs such as an ultrasonic cement evaluation log and/or a directional noise log to pinpoint potential gas sources or eliminate false gas sources. For example, an ultrasonic cement evaluation log can be used to identify gas channels along the casing/cement interface, which may help to pinpoint potential gas sources. As another example, a directional noise log can be used to identify if fluids are flowing up or down at a particular position along a cased wellbore, which may help to pinpoint potential gas sources or eliminate false gas sources. In at least some embodiments, squeeze target selection at block 406 involves displaying a pulsed neutron log, an ultrasonic cement evaluation log, and a directional noise log together to enable an operator to select a squeeze target. Additionally or alternatively, pattern recognition can be applied to one or more logs to facilitate or automate squeeze target selection. At block 408, at least one well intervention tool in the case wellbore related to obtained log or logs is directed to perform a squeeze operation for the selected squeeze target.

Embodiments disclosed herein include:

A: A method that comprises obtaining a pulsed neutron log as a function of position along a cased wellbore, analyzing the pulsed neutron log to identify a gas channel associated with a surface casing vent flow condition, selecting a squeeze target along the identified gas channel, and directing at least one well intervention tool in the cased wellbore to perform a squeeze operation for the selected squeeze target.

B: A system that comprises at least one well intervention tool configured to perform squeeze operations. The system also comprises at least one processor and a memory in communication with the at least one processor. The memory stores instructions that cause the at least one processor to obtain a pulsed neutron log as a function of position along a cased wellbore. The instructions also cause the at least one processor to display or identify, based on the pulsed neutron long, a gas channel associated with a surface casing vent flow condition. The instructions also cause the at least one processor to select or receive selection of a squeeze target along the identified gas channel. The instructions also cause the at least one processor to direct or display directions for the at least one well intervention tool to perform squeeze operations at the squeeze target.

C: A non-transitory computer-readable medium storing instruction that, when executed, cause a processor to obtain a pulsed neutron log as a function of position along a cased wellbore. The instructions, when executed, also cause a processor to display or identify, based on the pulsed neutron long, a gas channel associated with a surface casing vent flow condition. The instructions, when executed, also cause a processor to select or receive selection of a squeeze target along the identified gas channel. The instructions, when executed, also cause a processor to direct or display directions for a well intervention tool to perform squeeze operations at the squeeze target.

Each of the embodiments, A, B, and C, may have one or more of the following additional elements in any combination. Element 1: further comprising deploying a pulsed neutron logging tool with a BGO detector to collect data from which the pulsed neutron log is obtained. Element 2: further comprising obtaining an ultrasonic cement evaluation log as a function of position along the cased wellbore, and selecting the squeeze target along the identified gas channel based at least in part on the ultrasonic cement evaluation log. Element 3: further comprising deploying a circumferential acoustic scanning tool to collect data from which the ultrasonic cement evaluation log is obtained. Element 4: further comprising obtaining a directional noise log as a function of position along the cased wellbore, and selecting the squeeze target along the identified gas channel based at least in part on the directional noise log. Element 5; further comprising deploying an optical fiber along the cased wellbore to collect data from which the directional noise log is obtained. Element 6: further comprising analyzing the pulsed neutron log to identify a plurality of suspected gas source zones along the gas channel, wherein selecting the squeeze target comprises selecting one of the suspected gas source zones. Element 7: further comprising displaying the pulsed neutron log, an ultrasonic cement evaluation log, and a directional noise log together via a user interface, wherein a user selects the squeeze target in response to said displaying. Element 8: further comprising applying pattern recognition to the pulsed neutron log, an ultrasonic cement evaluation log, and a directional noise log, wherein a computer selects the squeeze target in response to said applying.

Element 9: further comprising a pulsed neutron logging tool with a Bismuth Germinate Oxide (BGO) detector and deployed in the cased wellbore, wherein the pulsed neutron logging tool collects data from which the pulsed neutron log is obtained. Element 10: wherein the instructions further cause the at least one processor to obtain an ultrasonic cement evaluation log as a function of position along the cased wellbore, and select or receive selection of the squeeze target along the identified gas channel based at least in part on the ultrasonic cement evaluation log. Element 11: further comprising a circumferential acoustic scanning tool deployed in the cased wellbore, wherein the circumferential acoustic scanning tool collects data from which the ultrasonic cement evaluation log is obtained. Element 12: wherein the instructions further cause the at least one processor to obtain a directional noise log as a function of position along the cased wellbore, and select or receive selection of the squeeze target along the identified gas channel based at least in part on the directional noise log. Element 13: further comprising an optical fiber deployed along the cased wellbore to collect data from which the directional noise log is obtained. Element 14: wherein the instructions further cause the at least one processor to display or identify a plurality of potential gas source zones along the gas channel, wherein one of the potential gas source zones is selected as the squeeze target. Element 15: further comprising a monitor in communication with the at least processor, wherein the monitor displays the pulsed neutron log, an ultrasonic cement evaluation log, and a directional noise log together, and wherein a user selects the squeeze target in response to the displayed logs. Element 16: wherein the instructions further cause the at least one processor to apply pattern recognition to the pulsed neutron log, an ultrasonic cement evaluation log, and a directional noise log, and select the squeeze target in response to the applied pattern recognition. Element 17: wherein the instructions, when executed, further cause the processor to display the pulsed neutron log, an ultrasonic cement evaluation log, and a directional noise log together.

Numerous variations and modifications will become apparent to those skilled in the art once the above disclosure is fully appreciated. It is intended that the following claims be interpreted to embrace all such variations and modifications where applicable.

1. A method that comprises:
obtaining a pulsed neutron log as a function of position along a cased wellbore;
analyzing the pulsed neutron log to identify a gas channel associated with a surface casing vent flow condition;
selecting a squeeze target along the identified gas channel; and
directing at least one well intervention tool in the cased wellbore to perform a squeeze operation for the selected squeeze target.

2. The method of claim 1, further comprising deploying a pulsed neutron logging tool with a Bismuth Germinate Oxide (BGO) detector to collect data from which the pulsed neutron log is obtained.

3. The method of claim 1, further comprising:
obtaining an ultrasonic cement evaluation log as a function of position along the cased wellbore; and
selecting the squeeze target along the identified gas channel based at least in part on the ultrasonic cement evaluation log.

4. The method of claim 3, further comprising deploying a circumferential acoustic scanning tool to collect data from which the ultrasonic cement evaluation log is obtained.

5. The method of claim 1, further comprising:
obtaining a directional noise log as a function of position along the cased wellbore; and
selecting the squeeze target along the identified gas channel based at least in part on the directional noise log.

6. The method of claim 5, further comprising deploying an optical fiber along the cased wellbore to collect data from which the directional noise log is obtained.

7. The method according to claim 1, further comprising analyzing the pulsed neutron log to identify a plurality of suspected gas source zones along the gas channel, wherein selecting the squeeze target comprises selecting one of the suspected gas source zones.

8. The method according to claim 1, further comprising displaying the pulsed neutron log, an ultrasonic cement evaluation log, and a directional noise log together via a user interface, wherein a user selects the squeeze target in response to said displaying.

9. The method according to claim 1, further comprising applying pattern recognition to the pulsed neutron log, an ultrasonic cement evaluation log, and a directional noise log, wherein a computer selects the squeeze target in response to said applying.

10. A system that comprises:
at least one well intervention tool configured to perform squeeze operations;
at least one processor; and
a memory in communication with the at least one processor, wherein the memory stores instructions that cause the at least one processor to:
obtain a pulsed neutron log as a function of position along a cased wellbore;
display or identify, based on the pulsed neutron long, a gas channel associated with a surface casing vent flow condition;
select or receive selection of a squeeze target along the identified gas channel; and
direct or display directions for the at least one well intervention tool to perform squeeze operations at the squeeze target.

11. The system of claim 10, further comprising a pulsed neutron logging tool with a Bismuth Germinate Oxide (BGO) detector and deployed in the cased wellbore, wherein the pulsed neutron logging tool collects data from which the pulsed neutron log is obtained.

12. The system of claim 10, wherein the instructions further cause the at least one processor to:
obtain an ultrasonic cement evaluation log as a function of position along the cased wellbore; and
select or receive selection of the squeeze target along the identified gas channel based at least in part on the ultrasonic cement evaluation log.

13. The system of claim 12, further comprising a circumferential acoustic scanning tool deployed in the cased wellbore, wherein the circumferential acoustic scanning tool collects data from which the ultrasonic cement evaluation log is obtained.

14. The system of claim 10, wherein the instructions further cause the at least one processor to:
obtain a directional noise log as a function of position along the cased wellbore; and
select or receive selection of the squeeze target along the identified gas channel based at least in part on the directional noise log.

15. The system of claim 14, further comprising an optical fiber deployed along the cased wellbore to collect data from which the directional noise log is obtained.

16. The system according to claim 10, wherein the instructions further cause the at least one processor to display or identify a plurality of potential gas source zones along the gas channel, wherein one of the potential gas source zones is selected as the squeeze target.

17. The system according to claim 10, further comprising a monitor in communication with the at least processor, wherein the monitor displays the pulsed neutron log, an ultrasonic cement evaluation log, and a directional noise log together, and wherein a user selects the squeeze target in response to the displayed logs.

18. The system according to claim 10, wherein the instructions further cause the at least one processor to:
apply pattern recognition to the pulsed neutron log, an ultrasonic cement evaluation log, and a directional noise log; and
select the squeeze target in response to the applied pattern recognition.

19. A non-transitory computer-readable medium storing instruction that, when executed, cause a processor to:
obtain a pulsed neutron log as a function of position along a cased wellbore;
display or identify, based on the pulsed neutron long, a gas channel associated with a surface casing vent flow condition;
select or receive selection of a squeeze target along the identified gas channel; and
direct or display directions for a well intervention tool to perform squeeze operations at the squeeze target.

20. The non-transitory computer-readable medium of claim 19, wherein the instructions, when executed, further cause the processor to:
display the pulsed neutron log, an ultrasonic cement evaluation log, and a directional noise log together.
